(19) United States
(12) Patent Application Publication
(10) Pub. No.: US 2004/0188952 A1
(43) Pub. Date: Sep. 30, 2004

(54) Cylinder head flat seal for combustion engines

(76) Inventor: Ralf Flemming, Langenbach (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/803,486

(22) Filed: Mar. 18, 2004

(30) Foreign Application Priority Data
Mar. 26, 2003 (DE) 103 13 534.0

(51) Int. Cl. F02F 11/00; E02B 13/00

(52) U.S. Cl. 277/592

(57) ABSTRACT

Flat seal, in particular cylinder head seal, for combustion engines is disclosed having at least one metal layer, in which at least one which pass-through opening is made. An outer sealing function is achieved by provision of several circumferential, parallel profile sumps of selectable shape in the area near the outer edge of the metal layer.

This application claims the benefit of German Application No. 103 13 534.0, filed Mar. 26, 2003.

### BACKGROUND OF THE INVENTION

1. Technical Field

The invention relates to a flat seal, in particular a cylinder head seal for combustion engines, having at least one metal layer, in which at least one pass-through opening is made.

2. Related Art

Due to pores, lumps and inclusions, particularly in cylinder head seals, leaks can occur. This is because a single sump cannot optimally seal this type of defect. In cases of poor tolerance fits, and/or casting errors in the cylinder head and/or the cylinder block, a single sump cannot ensure a good seal.

In DE-A 100 60 872, a flat seal with at least one metal layer was made known, in which at least one pass-through opening is made, where the or at least one of the metal layers is formed, at least partially, with a wave and/or sawtooth profile around the pass-through opening(s).

Using this flat seal, locally occurring influences can be managed better, without, however, being able to solve the problem cited above.

The invention addresses the task of better managing the sealing of a flat seal, in particular a cylinder head seal, in particular with regard to problem areas of peripheral components, such as poor tolerance fits between the cylinder head and cylinder block, or similar. In this manner, an increased lifespan of the flat seal, in particular the cylinder head seal, is to be achieved.

### SUMMARY OF THE INVENTION

The task is solved in that the outer seal is achieved by several profile sumps running in parallel, formed continuously around the perimeter, located close to the edge, with selectable contour.

The object of the invention thereby extends well beyond the state of the technology per DE-A 100 60 872, in that not only local influences, but also the outer seal can be included. This means that problem areas caused by the peripheral components can be directly optimally sealed, so that an increase in the lifespan can be achieved. Through several small sumps of selectable shape (wave and/or sawtooth style profiles), cavities or casting errors can also be compensated for. In addition, the indentations can be deliberately filled with coating material.

According to the invention, several parallel profile sumps thus perform the outer sealing function. If local influences, such as those addressed in DE-A 100 60 872, are also to be sealed in the same way, then it is also possible to provide single or multiple circumferential profile sumps for the pass-through openings and other pass-through holes for media transport. If a stopper is present next to a full sump in the area of at least one of the pass-through opening, the stopper can be made of at least one profile sump.

If the flat seal, especially the cylinder head seal, is made of several layers, then the alternative possibility also exists to make the profile sumps in the outer area either in only one of the layers, or in several layers. It is also conceivable that all layers be provided with profile sumps, which then, in the assembled condition, form several parallel profile sumps in various levels at the edge area.

Other types of shapes can also be made on the basis of forming identical profile sumps in several layers at the same level, near the edge, which then, in the assembled condition of the flat seal, in particular the cylinder head seal, are seated within each other or with their wave crests (sawtooth profiles) against each other.

The expert will select the most sensible type of shape for the profile sumps in the edge area of the flat seal, in particular the cylinder head seal, depending on the materials selected, especially the spring characteristics, in order to achieve improved sealing effects over a long period.

The filler materials for the valley areas in the profile sumps can be, for instance, elastomers, where their selection would depend on the spring characteristics of the metal base material.

It may also be sensible to make the circumferential profile sumps in such a manner that the parallel sumps have varying depths. Thus, for example, an outer wave-shaped profile sump can run parallel to one that has a sawtooth profile sump.

### THE DRAWINGS

The object of the invention is shown in the drawings, using an application example, and is described as follows. Shown are:

FIG. 1 Plan view of a flat seal, in particular a cylinder head seal

FIGS. 2 to 5 Sections through the flat seal shown in FIG. 1.

### DETAILED DESCRIPTION

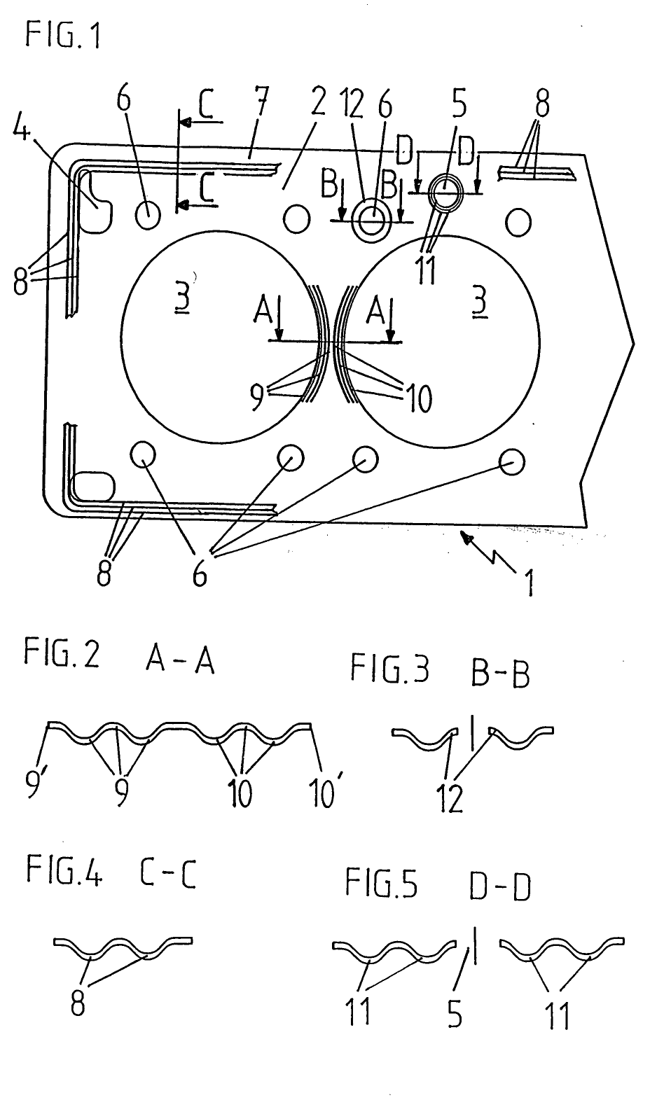

FIG. 1 shows, as an application example, a flat seal 1, which in the example has a single metal layer 2. As previously described, the flat seal can, however, comprise several layers, so that the application example per FIG. 1 does not represent an exclusive example. Combustion chamber pass-through openings 3 are made in the metal layer 2. In addition, pass-through holes 4, 5 for media passage (coolant, lubricant) are provided. Screw holes are indicated by the number 6. In FIG. 1 it can be seen that, in the area near the edge 7, the metal layer 2 is provided with parallel profile sumps 8 that serve as the outer seal.

These profile sumps can be formed as wave sumps as well as by sawtooth type profiles. Due to the parallel, small sumps, cavities or casting errors of peripheral components are compensated for. It is not recognizable here that the valleys in the profile sumps 8 are filled with coating material. The outer sealing function of the flat seal I is thereby performed only by the circumferential parallel profile sumps 8. The area around the pass-through openings 3 is also surrounded by circumferential profile sumps 9, 10, in several rows. It is merely implied that the pass-through holes 5 for media flow are surrounded by profile sumps 11. As needed, the screw holes 6 can also be surrounded by profile sumps 12.

The sections A-A, B-B, C-C, and D-D per FIGS. 2 to 5 show the cross sections in the associated sectional area of FIG. 1.

Thus FIG. 2 shows the section A-A through the combustion chamber side of the pass-through openings 3. On the combustion chamber side, partial sumps 9′, 10′ are provided, while the additional wave-shaped sumps 9, 10 are full sumps.

FIG. 3 shows the section B-B. It shows a screw hole 6, which is surrounded by a partial sump 12.

Section C-C, shown in FIG. 4, shows the edge area 7 near the outside, where full sumps are provided as profile sumps 8.

FIG. 5 shows section D-D, which represents a media flow. Here again full sumps are shown as profile sumps 11.

The expert will make the type and shape of each profile sump used dependent on the individual application, so that the examples shown in FIGS. 1 to 5 should be taken only as such.

1. A seal for combustion engines, comprising at least one metal layer having an outer edge region and at least one pass-through opening formed in the at least one metal layer; and a plurality of circumferential, parallel profile sumps formed in at least said outer edge region.

2. The seal of claim 1, wherein said profile sumps are formed as circumferential wave sumps.

3. The seal of claim 1, wherein said profile sumps are formed by a circumferential saw-tooth profile.

4. The seal of claim 1, wherein said profile sumps run parallel to one another and have the same shape.

5. The seal of claim 1, wherein said profile sumps run parallel to one another and have offset cross sections.

6. The seal of claim 1, wherein said profile sumps are filled with an elastomer-type coating material.

7. The seal of claim 1, wherein said at least one pass-through opening is surrounded by at least one associated circumferential profile sump.

8. The seal of claim 1, wherein in the presence of a stopper next to a full sump in the area of the at least one pass-through opening, the stopper is formed by at least one profile sump.
